(19) United States
(12) Patent Application Publication
(10) Pub. No.: US 2015/0215007 A1
(43) Pub. Date: Jul. 30, 2015

(54) WIRELESS POWER TRANSMISSION SYSTEM

(71) Applicant: Murata Manufacturing Co., Ltd., Nagaokakyo-shi (JP)

(72) Inventors: Shinji Goma, Nagaokakyo-shi (JP); Keiichi Ichikawa, Nagaokakyo-shi (JP)

(21) Appl. No.: 14/683,559

(22) Filed: Apr. 10, 2015

Related U.S. Application Data
(63) Continuation of application No. PCT/JP2013/073611, filed on Sep. 3, 2013.

(30) Foreign Application Priority Data
Dec. 14, 2012 (JP) 2012-272926

(51) Int. Cl. H04B 5/00; H02J 7/02

(52) U.S. Cl. CPC H04B 5/0037; H02J 7/025

(57) ABSTRACT

In a wireless power transmission system that transmits power from a power transmitting device to a power receiving device by electric field coupling, the power receiving device includes a power receiving module having a circuit for rectifying and smoothing an AC voltage which is generated between the active electrode and the passive electrode, a secondary battery, and a heat conducting plate that transfers heat which is generated in the power receiving module in power transmission from the power transmitting device to the power transmitting device. The power transmitting device includes a power transmission module which converts an input DC voltage to an AC voltage and applies the AC voltage between the active electrode and the passive electrode and a heat conducting plate which makes contact with the heat conducting plate and receives heat from the power receiving device.

### CROSS REFERENCE TO RELATED APPLICATIONS

The present application is a continuation of PCT/JP2013/073611 filed Sep. 3, 2013, which claims priority to Japanese Patent Application No. 2012-272926, filed Dec. 14, 2012, the entire contents of each of which are incorporated herein by reference.

### FIELD OF THE INVENTION

The present invention relates to a wireless power transmission system that transmits power to a power receiving device from a power transmitting device with electric field coupling.

### BACKGROUND OF THE INVENTION

As a representative system in which two devices are made close and power is transmitted between the two devices, known has been a power transmission system employing a magnetic field coupling method. The power transmission system employing the magnetic field coupling method transmits, using an electromagnetic field, power from a primary coil of a power transmitting device to a secondary coil of a power receiving device using a magnetic field. For example, Patent Document 1 discloses a non-contact charging device that supplies power to an electronic device (power receiving device) from a power transmitting device (power feeding device) in a non-contact manner so as to charge a battery in the electronic device.

In the non-contact charging device, the electronic device and the power transmitting device generate heat therein to be subjected to high temperature. For coping with this, in the non-contact charging device disclosed in Patent Document 1, a heat spreader is provided in the electronic device whereas a heat sink is provided in the power transmitting device. Heat that is generated when the power receiving coil is operated is transferred to ceramics, and then, is transferred to the heat spreader from the ceramics through a heat conductor. The heat spreader can release the heat of the power receiving coil to a space in a housing. This enables the heat in the electronic device and the heat in the power transmitting device to be released to the outside from the housing.

Patent Document 1: Japanese Unexamined Patent Application Publication No. 2003-272938

When the power receiving device is a portable electronic device or the like, the power receiving device is required to be reduced in size. Therefore, when the heat spreader for heat dissipation is provided as described in Patent Document 1, the device is increased in size by the size of the heat spreader, resulting in causing a problem. Further, as another power transmission system, a power transmission system employing an electric field coupling method has been also proposed. The electric field coupling method also has a problem that generated heat is larger than that in contact-type power transmission with a connector because the power receiving device is required to include a circuit for rectifying and smoothing an alternating-current (AC) voltage received. Particularly in recent years, a style that a “device is used (device is driven) while being charged” has been established with the spread of smartphones and tablet terminals. In terms of power, the largest power is required when the device is driven while charging a secondary battery. Accompanied with this, generated heat becomes the largest. When the temperature of the power receiving device is increased, risk factors including deterioration in the characteristics of the secondary battery, increase in a device failure rate, and a risk of low temperature burn of a user are increased. Due to this, the increase in the temperature of the power receiving device is not preferable.

### SUMMARY OF THE INVENTION

An object of the present invention is to provide a wireless power transmission system that suppresses the increase in temperature of a power receiving device and prevents the device from being increased in size even when the “device is driven while being charged” with high calorific value.

According to an aspect of the invention, there is provided a wireless power transmission system that transmits power from a power transmitting device to a power receiving device by electric field coupling. In the wireless power transmission system, the power receiving device includes a power receiving-side active electrode, a power receiving-side passive electrode connected to a reference potential, a secondary battery for accumulating power which is supplied from a power receiving-side circuit, a load which is driven by received power from the power receiving-side circuit when the power receiving-side circuit supplies the power, and by received power from the secondary battery when the power receiving-side circuit does not supply the power, a power receiving-side circuit including a circuit for rectifying and smoothing an alternating-current (AC) voltage which is generated between the power receiving-side active electrode and the power receiving-side passive electrode, a power receiving-side heat dissipation unit which dissipates heat from the power receiving-side circuit, and a power receiving-side heat conductor to which heat generated in the power receiving-side circuit in power transmission from the power transmitting device is transferred, the power transmitting device includes a power transmitting-side active electrode opposing the power receiving-side active electrode so as to be spaced from each other, a power transmitting-side passive electrode making contact with the power receiving-side passive electrode directly or opposing the power receiving-side passive electrode so as to be spaced from each other, a power transmitting-side circuit which converts an input direct-current (DC) voltage to an AC voltage and applies the AC voltage between the power transmitting-side active electrode and the power transmitting-side passive electrode, and a power transmitting-side heat conductor which receives heat from the power receiving-side heat conductor directly or indirectly, and a heat capacity of the power receiving-side heat dissipation unit is smaller than a heat capacity necessary for driving the load while charging the secondary battery and heat is transferred to the power transmitting-side heat conductor so as to ensure the heat capacity necessary for driving the load while charging the secondary battery.

Examples of the power receiving device include a portable electronic device (a smartphone, a tablet terminal, and the like), and the power receiving device is required to be further reduced in size. Therefore, it is difficult to ensure a space for providing a cooling unit in the power receiving device. For coping with this, the above-mentioned configuration enables heat, which is generated in the power receiving device when the device is driven while charging the secondary battery with the largest heat generation, to be conducted to the power transmitting device from the power receiving-side heat conductor through the power transmitting-side heat conductor. A usage mode in which the device is driven while charging the secondary battery is employed only in the case where the power receiving device is placed on the power transmitting device. Therefore, the heat capacity of a heat dissipation plate of the power receiving device needs not be as high as a level at which it appropriately dissipates heat generated when the device is driven while charging the secondary battery. The heat is transferred to the power transmitting-side heat conductor from the power receiving-side heat conductor, so that the heat dissipation unit, the electrode, and the like of the power transmitting device can be used as a heat dissipation unit for the power receiving device. This can suppress increase in the temperature in the power receiving device when the power is transmitted. Accordingly, there is a design margin for a dissipation of heat in the power receiving device, thereby reducing the power receiving device in size.

It is preferable that the power receiving-side heat conductor be made of metal and be electrically connected to the power receiving-side passive electrode.

With this configuration, for example, a part of the power receiving-side passive electrode can be made to function as the power receiving-side heat conductor.

It is preferable that the power transmitting-side heat conductor be made of metal and be electrically connected to the power transmitting-side passive electrode.

With this configuration, for example, a part of the power transmitting-side passive electrode can be made to function as the power transmitting-side heat conductor.

It is preferable that at least one of the power receiving-side heat conductor and the power transmitting-side heat conductor be covered with an electric insulator having a thermal conductivity higher than a thermal conductivity of air, and the power transmitting-side heat conductor receive heat from the power receiving-side heat conductor through the electric insulator.

With this configuration, the power receiving-side heat conductor can be prevented from being exposed from the housing of the power receiving device by covering it with the electric insulator. When the power receiving-side heat conductor is made of metal, preventing the exposure of the power receiving-side heat conductor makes it possible to avoid the electric contact with the outside.

It is preferable that at least one of the power transmitting device and the power receiving device include close-contacting unit which makes the power receiving-side heat conductor and the power transmitting-side heat conductor contact closely to each other with magnetic force.

With this configuration, close-contacting property between the power receiving-side heat conductor and the power transmitting-side heat conductor is enhanced with the magnetic force, thereby improving thermal conductivity. Further, positioning of the power receiving-side heat conductor and the power transmitting-side heat conductor can be easily performed with a transmitting-side magnet. This enables a user to unconsciously position the power receiving-side heat conductor and the power transmitting-side heat conductor.

According to the invention, increase in the temperature of a power receiving device can be suppressed and the power receiving device can be reduced in size.

### BRIEF DESCRIPTION OF DRAWINGS

FIG. 1 shows a plan view and a front cross-sectional view both illustrating a wireless power transmission system according to a first embodiment.

FIG. 2 is a circuit diagram of the wireless power transmission system.

FIG. 3 is a front cross-sectional view illustrating a wireless power transmission system according to a second embodiment.

FIG. 4 is a view illustrating another example of the configuration of a wireless power transmission system.

### DETAILED DESCRIPTION OF THE EXEMPLARY EMBODIMENTS

### First Embodiment

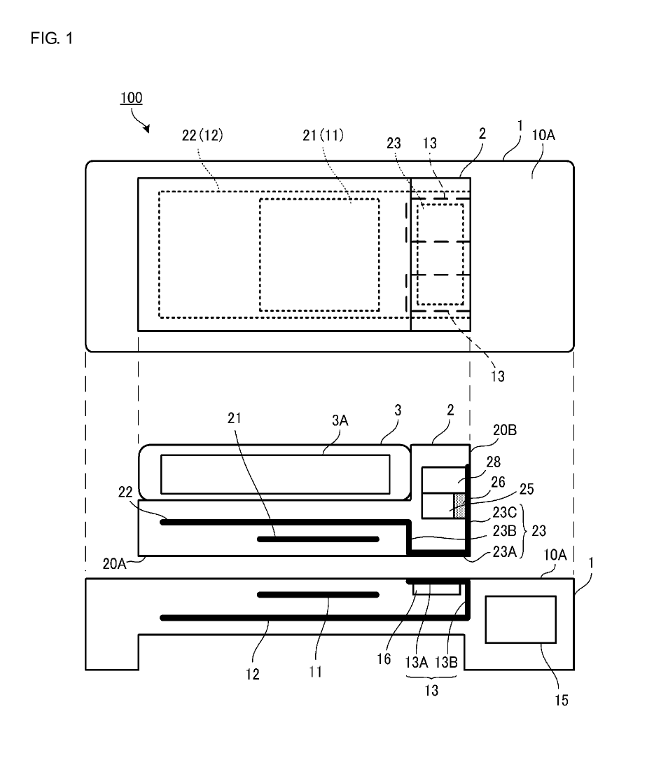

FIG. 1 shows a plan view and a front cross-sectional view illustrating a wireless power transmission system according to a first embodiment.

A wireless power transmission system 100 according to the embodiment is constituted by a power transmitting device 1 and a power receiving device 2. In this example, description is made while the power receiving device 2 is a jacket covering an outer circumferential frame of a tablet-type electronic device 3. In the plan view of FIG. 1, the electronic device 3 is omitted.

The power receiving device 2 is placed on the power transmitting device 1. As will be described in detail later, a power receiving module 25 is configured in the power receiving device 2. Further, the power receiving module 25 is connected to the electronic device 3 through a connector in the power receiving device 2 and charges a secondary battery 3A of the electronic device 3. That is to say, the power transmitting device 1 is a charging platform of the electronic device 3.

The power receiving device 2 may not be the jacket that is attached to the electronic device 3 but may be a device in which the power receiving device 2 in the embodiment and the electronic device 3 are integrated. Examples thereof include a cellular phone, a personal digital assistant (PDA), a portable music player, a notebook-type personal computer (PC), a digital camera and so on.

A housing of the power transmitting device 1 has a horizontal placement surface 10A and the power receiving device 2 is placed on the placement surface 10A. Hereinafter, the side (upper side in the drawing) of the placement surface 10A on which the power receiving device 2 is placed is assumed to the upper side. The power transmitting device 1 includes an active electrode 11 and a passive electrode 12 that are parallel with the placement surface 10A. The active electrode 11 is provided at the side of the placement surface 10A. The passive electrode 12 is larger than the active electrode 11 and is provided at the lower side of the active electrode 11. The active electrode 11 and the passive electrode 12 are made of Cu or Ag.

The power transmitting device 1 includes a power transmission module 15. The power transmission module 15 converts an input DC voltage to an AC voltage and boosts the AC voltage. The power transmission module 15 applies the boosted AC voltage between the active electrode 11 and the passive electrode 12.

The power transmitting device 1 includes a heat conducting plate 13 for receiving heat from the power receiving device 2. The heat conducting plate 13 is made of copper or aluminum. The heat conducting plate 13 is constituted by a flat plate portion 13A and a connecting portion 13B. The flat plate portion 13A is parallel with the passive electrode 12. The connecting portion 13B is provided so as to be perpendicular to the flat plate portion 13A and electrically connects the flat plate portion 13A and the passive electrode 12. The planar portion 13A is provided along the placement surface 10A such that the entire surface is exposed to the placement surface 10A. The heat conducting plate 13, in particular, the planar portion 13A may be formed by a metal film. The planar portion 13A may not be connected to the passive electrode 12. The heat conducting plate 13 may not be another member and may be a part of the passive electrode 12.

The housing of the power transmitting device 1 is made of a material having high thermal conductivity. Heat transferred to the heat conducting plate 13 from the power receiving device 2 through a heat conducting plate 23 is also conducted to the passive electrode 12 and is radiated to the outside through the housing of the power transmitting device 1.

A magnet (close-contacting unit) 16 is provided on the lower surface of the heat conducting plate 13. The magnet 16 is a magnet having flexibility, such as a rubber magnet and a bond magnet. A ferromagnetic member (not illustrated) is provided in the vicinity of the heat conducting plate 23, which will be described later, included in the power receiving device 2. The magnet 16 attracts the ferromagnetic member, so that the planar portion 13A of the heat conducting plate 13 and the heat conducting plate 23 are made to contact closely to each other.

When the heat conducting plate 23 is formed by a ferromagnetic member, it is unnecessary that the ferromagnetic member is provided in the vicinity of the heat conducting plate 23. Further, the position at which the magnet 16 is provided can be changed appropriately as long as the heat conducting plates 13 and 23 are configured to contact closely to each other with magnetic force. For example, when a part of the housing of the power receiving device 2 is made of metal, the following configuration may be employed. That is, the magnet 16 is arranged so as to attract the metal portion, and the heat conducting plates 13 and 23 are made to contact closely to each other when the magnet 16 attracts the metal of the housing of the power receiving device 2. Alternatively, a magnet may be provided on the power receiving device 2 side or no magnet may be provided on any of the power transmitting device 1 and the power receiving device 2.

The housing of the power receiving device 2 has a flat rear surface 20A. The power receiving device 2 is placed on the power transmitting device 1 while the rear surface 20A faces downward such that the rear surface 20A contacts closely to the placement surface 10A of the power transmitting device 1. The front view of FIG. 1 illustrates a state where the power transmitting device 1 and the power receiving device 2 are slightly separated from each other for the convenience of description.

The power receiving device 2 includes an active electrode 21 and a passive electrode 22 that are parallel with the rear surface 20A. The active electrode 21 and the passive electrode 22 are made of Cu or Ag. The active electrode 21 is provided at the side of the rear surface 20A. The passive electrode 22 is larger than the active electrode 21 and is provided such that the active electrode 21 is interposed between the passive electrode 22 and the rear surface 20A. When the power receiving device 2 is placed on the power transmitting device 1, the active electrode 11 and the active electrode 21 oppose each other with a gap therebetween and the passive electrode 12 and the passive electrode 22 also oppose each other with a gap therebetween.

The power receiving device 2 includes the power receiving module 25. In the power transmitting device 1, when a voltage is applied between the active electrode 11 and the passive electrode 12, an electric field is generated between the active electrodes 11 and 21 arranged to oppose each other and the passive electrodes 12 and 22 are connected directly through the heat conducting plates 13 and 23. The power receiving module 25 rectifies and smoothes the AC voltage generated between the active electrode 21 and the passive electrode 22 by electric field coupling to the power transmitting device 1 so as to convert it to a DC voltage. The power receiving device 2 outputs the DC voltage to the electronic device 3. With this, the secondary battery 3A is charged in the electronic device 3.

The power receiving device 2 includes a heat sink (power receiving-side heat dissipation unit) 28 having a plurality of fins. The heat sink 28 has a heat capacity enough to dissipate heat that is generated in the power receiving device 2 when the power receiving device 2 is driven alone.

Further, the power receiving device 2 includes the heat conducting plate 23 that directly makes contact with the heat conducting plate 13 of the power transmitting device 1 and conducts heat to the heat conducting plate 13. The heat conducting plate 23 is formed by a metal plate made of copper or aluminum. The heat conducting plate 23 is constituted by a parallel portion 23A, a connecting portion 23B, and a side surface portion 23C. The parallel portion 23A is parallel with the passive electrode 22. The connecting portion 23B is provided so as to be perpendicular to the parallel portion 23A and electrically connects the parallel portion 23A and the passive electrode 22. The side surface portion 23C is provided so as to be perpendicular to the parallel portion 23A and makes contact with the power receiving module 25 through a heat transfer member 26. The parallel portion 23A is provided along the rear surface 20A such that the entire surface is exposed to the rear surface 20A. The side surface portion 23C is provided along a side surface 20B orthogonal to the rear surface 20A. Heat from the power receiving module 25 is transferred to the side surface portion 23C through the heat transfer member 26.

It should be noted that the heat transfer member 26 is formed by a member having high thermal conductivity and electric insulating property, for example, is formed by a member having high thermal conductivity such as rubber, resin or the like. The size (thickness) of the heat transfer member 26 is set in consideration of the thermal conductivity and the thermal resistance of a material forming the heat transfer member 26. For example, when the heat transfer member 26 is formed by the rubber having high thermal conductivity, the housing surface temperatures of the electronic device 3 and the power receiving device 2 described as a power receiving jacket are required to be not exceeding the temperature rise limit of 85° C. defined by the IEC Standard 60335-1 and therefore, the thickness of the heat transfer member 26 is set in accordance with the standard.

The heat conducting plate 23, in particular, the planar portion 23A may be formed by a metal film. The planar portion 23A may not be connected to the passive electrode 22. The heat conducting plate 23 may not be another member and may be a part of the passive electrode 22.

When the power receiving device 2 is placed on the power transmitting device 1, the heat conducting plate 13 makes surface-contact with the heat conducting plate 23. In general, when the device is driven while charging the secondary battery 3A, supply power is the largest and heat generation is also the largest with the supply power. At the same time, in such a usage mode, the power receiving device 2 is necessarily placed on the power transmitting device 1. When the power receiving module 25 of the power receiving device 2 generates heat in the power transmission to the power receiving device 2 from the power transmitting device 1, the heat is transferred to the heat conducting plate 13 from the heat conducting plate 23. That is to say, the heat generated in the power receiving device 2 is conducted to the power transmitting device 1. In this case, the heat conducting plate 13 and the heat conducting plate 23 are made of metal, so that heat conduction therebetween is made efficiently. With this, the heat of the power receiving device 2 is released to the power transmitting device 1 so as to prevent the temperature in the power receiving device 2 from being increased. As a result, heat can be dissipated through the power transmitting device necessarily even if the heat dissipation unit included in the power receiving device 2 does not have a heat capacity enough to dissipate heat which is generated when the device is driven while charging the secondary battery 3A. This can prevent the temperature of the surface of the housing of the power receiving device 2 from being increased. It should be noted that the heat conducted to the power transmitting device 1 is radiated from overall the housing of the power transmitting device 1.

In addition, the magnet 16 improves contacting property between the heat conducting plate 13 and the heat conducting plate 23 so as to improve thermal conducting efficiency to the power transmitting device 1 from the power receiving device 2. This enables heat of the power receiving device 2 to be dissipated more efficiently. Further, the heat conducting plate 13 and the heat conducting plate 23 are made contact with each other with the magnetic force of the magnet 16. With this, the active electrodes 11 and 21 are positioned so as to oppose each other. This enables a user to place the power receiving device 2 on the power transmitting device 1 such that the active electrodes 11 and 21 oppose each other unconsciously. Therefore, power is not transmitted in a state where the power receiving device 2 is not placed on the power transmitting device 1 with an appropriate positional relation. That is, no power is transmitted in an abnormal state. This can also suppress abnormal overheating of the power transmitting device 1 and the power receiving device 2 due to lowered power transmission efficiency.

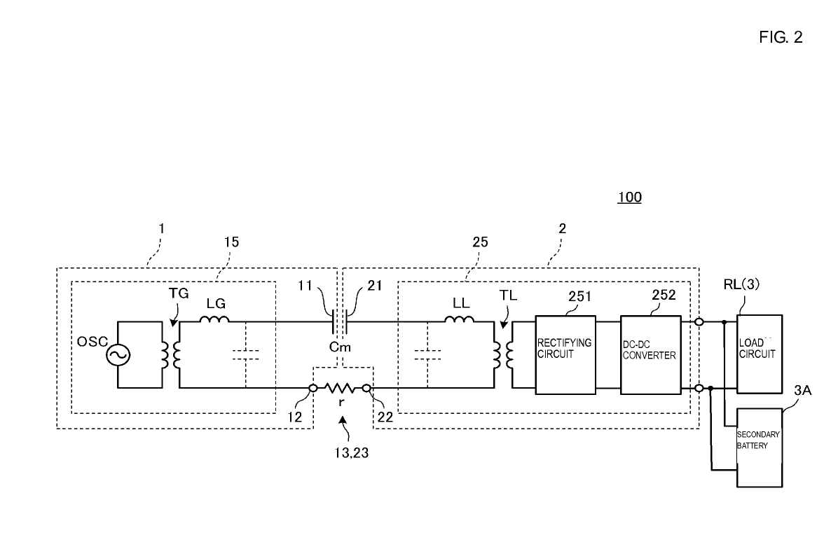

FIG. 2 is a circuit diagram illustrating the wireless power transmission system 100.

The power transmitting device 1 is connected to a household outlet of AC 100 V to 240 V, for example, through an AC adapter (not illustrated). The AC adapter converts a voltage of AC 100 V to 240 V to a voltage of DC 5V or 12V and inputs it to the power transmitting device 1. The power transmitting device 1 is operated using the input DC voltage as a power source.

The power transmission module 15 of the power transmitting device 1 includes a high-frequency voltage generation circuit OSC, a boosting transformer TG, and an inductor LG. The high-frequency voltage generation circuit OSC generates a high-frequency voltage of 100 kHz to several tens MHz, for example. A boosting circuit with the boosting transformer TG and the inductor LG boosts the voltage that is generated by the high-frequency voltage generation circuit OSC and applies it between the active electrode 11 and the passive electrode 12.

The power receiving device 2 includes the power receiving module 25 and a load circuit RL corresponding to the electronic device 3 is connected to the power receiving module 25. The power receiving module 25 is connected between the active electrode 21 and the passive electrode 22. The power receiving module 25 includes a step-down circuit with an inductor LL and a step-down transformer TL, a rectifying circuit 251 which converts the stepped-down AC voltage to a DC voltage, and a DC-DC converter 252 which outputs a defined DC voltage to the load circuit RL.

A resistance r that is connected between the passive electrode 12 of the power transmitting device 1 and the passive electrode 22 of the power receiving device 2 corresponds to a contact resistance configured on a contact portion between the passive electrodes 12 and 22, that is, a contact portion between the heat conducting plate 13 which is electrically connected to the passive electrode 12 and the heat conducting plate 23 which is electrically connected to the passive electrode 22. A capacitor Cm that is connected between the active electrodes 11 and 21 corresponds to a capacitor which is generated between the active electrodes 11 and 21.

When a resistance value of the contact resistance r is expressed by r and a capacity of the capacitor Cm on the capacity coupling portion is expressed by Cm, a relation of r<<1/ωCm is satisfied. Thus, the passive electrodes 12 and 22 of the power transmitting device 1 and the power receiving device 2 conduct with each other, so that a potential of the power receiving device-side passive electrode 22 is substantially equivalent to a potential of the power transmitting device-side passive electrode 12. As a result, the potential of the power receiving device-side passive electrode 22 is stabilized so as to suppress fluctuation of a ground potential and leakage of an unnecessary electromagnetic field. In addition, a stray capacitance is suppressed so as to enhance the coupling degree and obtain high transmission efficiency.

Meanwhile, when the heat conducting plates 13 and 23 are not electrically connected to the passive electrodes 12 and 22, respectively, the resistance r in FIG. 2 is expressed by a capacity.

Among the circuits as illustrated in FIG. 2, in particular, the power receiving module 25 has a relatively large heat generation amount and the heat is transferred to the power transmitting device 1 from the heat conducting plate 23 through the heat conducting plate 13. Then, the heat from the power receiving module 25 is dissipated from the power transmitting device 1. Accordingly, the increase in the temperature of the power receiving module 25 is suppressed, thereby avoiding a problem of failure of the power receiving module 25 or deterioration in the characteristics.

The housing of the power receiving device 2 is also made of a material having high thermal conductivity preferably in the same manner as the power transmitting device 1. In this case, heat of the power receiving device 2 is also dissipated through the housing of the power transmitting device 1 and the housing of the power receiving device 2. The sizes and the like of the heat conducting plates 13 and 23 can be changed appropriately. The contact area of the heat conducting plates 13 and 23 is preferably larger in order to enhance the thermal conducting efficiency.

### Second Embodiment

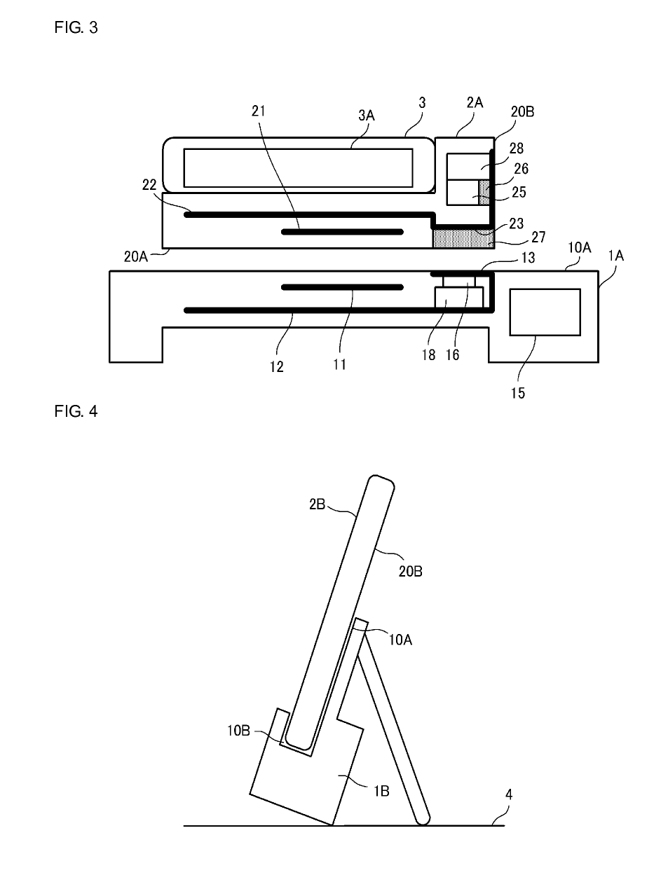

FIG. 3 is a front cross-sectional view illustrating a wireless power transmission system according to a second embodiment. The second embodiment is different from the first embodiment in a point that the heat conducting plate 13 of a power transmitting device 1A and the heat conducting plate 23 of a power receiving device 2A do not make contact with each other directly. It should be noted that the same reference numerals as those in the first embodiment denote the same members and description thereof is omitted.

The heat conducting plate 23 included in the power receiving device 2A is not exposed to the rear surface 20A of the power receiving device 2A and is provided at the inner side from the rear surface 20A. A heat transfer member 27 having electric insulating property is provided between the heat conducting plate 23 and the rear surface 20A. In other words, the heat conducting plate 23 is covered with the heat transfer member 27 so as not to be exposed from the housing of the power receiving device 2. Heat generated in the power receiving module 25 is conducted to the heat conducting plate 13 from the heat conducting plate 23 through the heat transfer member 27. Thus, the heat conducting plate 23 is not exposed, so that appearance of the power receiving device 2 is not degraded. Further, exposure is prevented so as to prevent the heat conducting plate 23 from making electric contact with the outside.

Although the heat conducting plate 23 of the power receiving device 2A is covered with the heat transfer member 27 having electric insulating property in the above description, the heat conducting plate 13 of the power transmitting device 1A may be covered with a heat transfer member having electric insulating property. Also in this case, heat generated in the power receiving module 25 is conducted to the heat conducting plate 13 from the heat conducting plate 23 through the heat transfer member.

The heat transfer member 27 is a member having high thermal conductivity, and is a metal oxide film or a ceramic plate, for example. The thickness of the heat transfer member 27 can be changed appropriately. As in the heat transfer member 26 in the first embodiment, the size (thickness) of the heat transfer member 27 is set in consideration of the thermal conductivity and the thermal resistance of a material forming the heat transfer member 27. For example, when the housing of the power transmitting device 1 is made of metal, the thickness of the heat transfer member 27 is set based on the IEC Standard 60335-1, that is, the housing surface temperature should not be higher than 60° C.

The power transmitting device 1A includes a heat sink (heat dissipation unit) 18 having a plurality of fins. The heat sink 18 dissipates heat received from the power receiving device 2A and heat generated from the power transmission module 15 and the like. This can further enhance dissipation efficiency of the power transmitting device 1A.

As described above in the first and second embodiments, according to the invention, heat of the power receiving device is dissipated through the power transmitting device so as to suppress the increase in the temperature of the power receiving device. Therefore, a size in required dissipation design in the power receiving device is minimized, thereby reducing the power receiving device in size.

Although the power receiving device is configured to be placed (transversely installed) on the horizontal placement surface of the power transmitting device in the above-mentioned embodiments, the power receiving device may be configured to stand against (be vertically installed on) the power transmitting device for power transmission.

FIG. 4 is a view illustrating another example of the configuration of a wireless power transmission system. FIG. 4 is a side view in a state where an electronic device to which a jacket corresponding to the power receiving device according to the invention is attached is placed on a power transmitting device. As illustrated in FIG. 4, the electronic device (hereinafter, referred to as a power receiving device 2B) to which the jacket is attached has the same configuration as those in the first and second embodiments. A power transmitting device 1B is configured to be installed such that the placement surface 10A contacting closely to the rear surface 20A of the power receiving device 2B is inclined with respect to a horizontal installation surface (for example, a table) 4. The power transmitting device 1B has a groove 10B for placing the power receiving device 2B therein and the power receiving device 2B is inserted into the groove so as to be installed on the power transmitting device 1B. Electric power is transmitted to the power receiving device 2B from the power transmitting device 1B and heat is conducted to the power transmitting device 1B from the power receiving device 2B. The configurations of power transmission and heat conduction are the same as those in the first and second embodiments and description thereof is omitted.

### REFERENCE SIGNS LIST

1, 1A, 1B POWER TRANSMITTING DEVICE
2, 2A, 2B POWER RECEIVING DEVICE
3 ELECTRONIC DEVICE
3A SECONDARY BATTERY
10A PLACEMENT SURFACE
11 ACTIVE ELECTRODE (POWER TRANSMITTING-SIDE ACTIVE ELECTRODE)
12 PASSIVE ELECTRODE (POWER TRANSMITTING-SIDE PASSIVE ELECTRODE)
13 HEAT CONDUCTING PLATE (POWER TRANSMITTING-SIDE HEAT CONDUCTOR)
15 POWER TRANSMISSION MODULE (POWER TRANSMITTING-SIDE CIRCUIT)
16 MAGNET (CLOSE-CONTACTING UNIT)
18 HEAT SINK (HEAT DISSIPATION UNIT)
20A REAR SURFACE
20B BOTTOM SURFACE
21 ACTIVE ELECTRODE (POWER RECEIVING-SIDE ACTIVE ELECTRODE)
22 PASSIVE ELECTRODE (POWER RECEIVING-SIDE PASSIVE ELECTRODE)
23 HEAT CONDUCTING PLATE (POWER RECEIVING-SIDE HEAT CONDUCTOR)
25 POWER RECEIVING MODULE (POWER RECEIVING-SIDE CIRCUIT)
26, 27 HEAT TRANSFER MEMBER
28 HEAT SINK (POWER RECEIVING-SIDE HEAT DISSIPATION UNIT)
100 WIRELESS POWER TRANSMISSION SYSTEM

1. A wireless power transmission system comprising:
a power receiving device including:
a power receiving-side active electrode;
a power receiving-side passive electrode coupled to a reference potential; a power receiving-side circuit that rectifies and smoothes an alternating-current (AC) voltage that is generated between the power receiving-side active electrode and the power receiving-side passive electrode; a battery that accumulates power supplied from the power receiving-side circuit;
a load that is driven by power from the power receiving-side circuit or by power from the battery when the power receiving-side circuit does not supply power;
a heat sink that dissipates heat from the power receiving-side circuit; and
a power receiving-side heat conductor that transfers heat generated in the power receiving-side circuit during power transmission to the power receiving device; and
a power transmitting device including:
a power transmitting-side active electrode that opposes the power receiving-side active electrode when the power receiving device is placed on the power transmitting device;
a power transmitting-side passive electrode that opposes the power receiving-side passive electrode when the power receiving device is placed on the power transmitting device;
a power transmitting-side circuit that converts an input direct-current (DC) voltage to an AC voltage and applies the AC voltage between the power transmitting-side active electrode and the power transmitting-side passive electrode; and
a power transmitting-side heat conductor that receives heat from the power receiving-side heat conductor when the power receiving device is placed on the power transmitting device.

2. The wireless power transmission system according to claim 1, wherein the power transmitting-side heat conductor receives heat from the power receiving-side heat conductor directly or indirectly.

3. The wireless power transmission system according to claim 1, wherein the heat sink of the power receiving device comprises a heat capacity that is smaller than a heat capacity required to drive the load while charging the battery.

4. The wireless power transmission system according to claim 3, wherein heat is transferred to the power transmitting-side heat conductor so as to ensure a heat capacity necessary to drive the load while the battery is charged.

5. The wireless power transmission system according to claim 1, wherein the power receiving-side heat conductor comprises metal and is electrically connected to the power receiving-side passive electrode.

6. The wireless power transmission system according to claim 1, wherein the power transmitting-side heat conductor comprises metal and is electrically connected to the power transmitting-side passive electrode.

7. The wireless power transmission system according to claim 1, wherein the power receiving device further comprises an electric insulator that covers the power receiving-side heat conductor, the electric insulator having a thermal conductivity higher than a thermal conductivity of air.

8. The wireless power transmission system according to claim 7, wherein the power receiving-side heat conductor receives heat from the power receiving-side heat conductor through the electric insulator.

9. The wireless power transmission system according to claim 1, wherein the power transmitting device further comprises an electric insulator that covers the power transmitting-side heat conductor, the electric insulator having a thermal conductivity higher than a thermal conductivity of air.

10. The wireless power transmission system according to claim 9, wherein the power receiving-side heat conductor receives heat from the power receiving-side heat conductor through the electric insulator.

11. The wireless power transmission system according to claim 1, wherein the power transmitting device includes a magnet configured to magnetically couple the power receiving-side heat conductor and the power transmitting-side heat conductor.

12. The wireless power transmission system according to claim 11, wherein the magnet is disposed in the power transmitting device, such that a magnetic force of the magnet causes the power receiving-side active electrode to directly oppose the power transmitting-side active electrode when the power receiving device is placed on the power transmitting device.

13. The wireless power transmission system according to claim 1, wherein the power receiving device includes a magnet configured to magnetically couple the power receiving-side heat conductor and the power transmitting-side heat conductor.

14. The wireless power transmission system according to claim 13, wherein the magnet is disposed in the power transmitting device, such that a magnetic force of the magnet causes the power receiving-side active electrode to directly oppose the power transmitting-side active electrode when the power receiving device is placed on the power transmitting device.

15. The wireless power transmission system according to claim 1, wherein the power transmitting-side heat conductor comprises a conductive heat plate the includes a first portion extending perpendicularly from the power transmitting-side passive electrode and a second portion extending perpendicularly from the first portion and parallel to the power transmitting-side passive electrode.

16. The wireless power transmission system according to claim 15, wherein the second portion of the conductive heat plate extends along a portion of a surface of the power transmitting device.

17. The wireless power transmission system according to claim 16, wherein the power transmitting device includes a magnet disposed under the second portion of the conductive heat plate and configured to magnetically couple the power receiving-side heat conductor and the power transmitting-side heat conductor.

18. The wireless power transmission system according to claim 17, wherein the power receiving-side heat conductor comprises a first portion extending perpendicularly from the power receiving-side passive electrode and a second portion extending perpendicularly from the first portion and parallel to the power receiving-side passive electrode.

19. The wireless power transmission system according to claim 18, wherein the second portion of the power receiving-side heat conductor extends along a portion of a surface of the power receiving device.

20. The wireless power transmission system according to claim 19, wherein the second portion of the power transmitting-side of the conductive heat plate contacts the second portion of the power receiving-side heat conductor when the power receiving device is placed on the power transmitting device.
